(19) United States
(12) Patent Application Publication
(10) Pub. No.: US 2016/0262407 A1
(43) Pub. Date: Sep. 15, 2016

(54) Spray Dried Doughnut Base Powder Composition

(71) Applicant: International Foodstuffs Co., LLC, Sharjah (AE)

(72) Inventors: Virender Kumar, Sharjah (AE); Mangesh Pandurang Varade, Sharjah (AE); Appa Baban Kamble, Sharjah (AE); Dipti Sugandh, Sharjah (AE); Jose Anibal Trujillo Quijano, Pucallpa (PE)

(21) Appl. No.: 14/656,776

(22) Filed: Mar. 13, 2015

(51) Int. Cl. A21D 10/00; A21D 13/00

(52) U.S. Cl. CPC A21D 10/005; A21D 13/0096

(57) ABSTRACT

Disclosed are processes for preparation of spray dried powder and utilization as an ingredient in the preparation of fried bakery products particularly doughnuts and types thereof. This doughnut base powder is spray dried with emulsifiers and stabilizers to provide improved eating and keeping qualities of the doughnuts made thereof. This base powder includes fat from animal, vegetable, or dairy origin, emulsifiers, water soluble protein solids, salt, carbohydrates and stabilizers. The above compositions can be directly added with the flour, yeast or chemical leavening agents as well as supplemented with optional flavor, color and preservative to produce either an yeast raised or a cake doughnut with or without the utilization of eggs.

### TECHNICAL FIELD

The disclosures relate generally to the field of processes for preparation of spray dried powder and utilization as an ingredient in the preparation of fried bakery products, and more particularly, to processes and compositions that provide a doughnut base powder or base to obtain doughnuts having increased tenderness, better eating qualities and increased shelf life.

### BACKGROUND

The present invention pertains to a spray dried doughnut base powder which enables the food manufacture to only add flour, leavening agents or yeast, desirable flavor and color to manufacture doughnuts.

Two types of doughnuts have been produced by common practice. One type is produced by utilizing yeast to raise the dough and is sold as yeast doughnuts while the other, by utilizing chemical leavening agents for raising the dough which is commonly sold as cake doughnuts.

Most doughnut mixes sold commercially are pre blended mixtures of shortening, milk solids, salt, sugar, emulsifiers, color, flavor, yeast or chemical leavening agents as well as egg powder or require the use of whole eggs. Commercial bakeries frequently prefer that ingredients such as flour, color, flavor, leavening agents, egg solids or egg yolks not be included in the mix and added rather at the time of preparation of doughnuts.

This invention relates to a spray dried doughnut base powder comprising of 20-50% fat as an alternative to the blended doughnut mix consisting of shortening with emulsifiers and stabilizers. Compared to the addition of shortening and emulsifiers separately, the spray dried doughnut base powder provides improved dispensability of the shortening and emulsifiers and improves functionality. This contributes to enhanced aeration and dough volume thus providing a finer and even crumbs structure with a softer texture. The doughnut base powder comprise of 20-50% by weight of fat, 1-5% by weight of one or more proteins, 0.5-10% by weight of one or more emulsifier system, 1-5% by weight of water and the balance is made up of salt, non-starchy carbohydrates, antioxidants and stabilizers. Optionally flavor, color and preservatives can be supplemented to the composition. The above composition can be added directly to flour, water, leavening agents for preparation of both yeast raised and chemically leavened cake doughnuts.

The present existing patents U.S. Pat. No. 0,119,232 A1 refers to co-processed emulsifier/carrier system which is spray dried and then added to dry mixture of full fat baked good mix particularly used for preparation of cakes. This patent contains only spray dried emulsifiers and carriers which are added to the full fat containing dry mix of baked goods particularly cakes to enhance cake volume and keeping qualities.

U.S. Pat. No. 0,110,494A1 describes a lipid-coated functional bakery ingredients that contains all bakery ingredients of enzymes, acidulates, hydrocolloids, starches, yeast, sugar and flavors. The composition described in US patent are particularly useful in baked products particularly bread which is raised using yeast. This patent describes the emulsion blend containing at least 50 wt. % triglyceride fat to produce a spray dried lipid coated functional bakery ingredient which is then mixed with flour and water to obtain a baked product particularly bread.

Further in all the aforesaid patents the utilization of spray dried powders as bakery ingredient in fried bakery products particularly doughnuts is not mentioned.

The spray dried doughnut base powder is a very unique product having a greater shelf life, good stability due to oxygen barrier provided by the fat, less logistics and packaging cost. The powder is easily mixed with flour and cold water, and product is spray dried powder which is easy to store and preserve. The use of this doughnut base powder leads to a simplified and shorter process for preparing doughnuts conveniently in households and food service. This is mainly due to increasing demand for more and more time saving and convenient food preparation methods. In addition, manufacturers can reduce the number of ingredients required in the manufacturing process and storage as well as produce finished goods with longer shelf life.

### SUMMARY

Disclosed is a spray dried doughnut base powder, which can be used for making of both yeast raised and cake doughnuts without the use of eggs or egg solids. The base powder comprises about 1 to 5% by weight water, about 20 to 50% by weight of fat, about 1 to 5% by weight of one or more proteins, 0.5 to 10% by weight of one or more of emulsifier. Preferably a doughnut base powder may contain effective amount of stabilizers and antioxidants. The invention is a spray dried base powder product which has good mixing characteristics and is able to give softness and volume to the doughnuts.

Embodiments of the invention can include one or more or any combination of the above features and configurations. Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### DETAILED DESCRIPTION

Before the present compounds, compositions, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting. In addition, the present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a surfactant” includes mixtures of two or more such surfactants, and the like.

“Optional” or “optionally” means that the subsequently described event or circumstance can or cannot occur, and that the description includes instances where the event or circumstance occurs and instances where it does not. For example, the phrase “optional fragrances” means that a fragrance may or may not be present in the compositions described herein.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

The spray dried doughnut base powder contains about 1-5% water. Preferably containing 3-4% water.

The doughnut base powder composition of the present invention contains about 20 to 50% by weight of an edible fat containing one or more fats, wherein the fat component is preferably solid or semi-solid at room temperature having a slip melting point of at least 30° C. The fat have slip melting point of 30-40° C. which will exert considerable desired effect during proofing process rather than the mixing of the dough. The fat component can be selected from numerous sources. Preferably the fat component is of animal, vegetable or dairy origin. The refined and deodorized fat component can be selected from plant oils, such as soybean oil, sunflower oil, canola oil, palm oil, palm kernel oil, coconut oil, safflower oil, corn oil, olive oil, peanut oil and cotton seed oil which can be used alone or as a mixture of two or more thereof. Hydrogenated, Fractionated, Interesterified chemically or enzymatically, single or combination of two or more fat used can be selected according to the final use of the powder. The fat should be fortified with antioxidants such as Natural Tocopherols, Ascorbyl Palmitate, or synthetic ones like Tertiary butyl hydroquinone (TBHQ) , Butylated hydroxytoluene (BHT), Butylated hydroxytoluene (BHA). Preferably Ascorbyl Palmitate or Oleate can be used at levels of 100-400 ppm.

The fat component having more crystallized fat in low temperature is suitable for product applications in fried bakery products such as doughnut. Preferable a fat component roughly having >30% crystallized fat at 20° C. and >10% crystallized fat at 30° C. (measured by pulsed Nuclear Magnetic Resonance according to the AOCS method cd 16693 or IUPAC parallel method 2.150a) is important for providing desired effect during proofing of the dough and enhance softness thus providing better eating qualities in such products.

Preferably the protein component can be selected from dairy or plant sources. Suitable proteins are derived from Caseinate, whey protein base powder or isolates, skimmed milk powder (low or high heat), butter milk powder, soy protein base powder or isolates, wheat proteins and pea protein isolates. Combination of one or more protein is also possible to use in the present invention. Emulsifying plant extracts such as gum Arabic, native and modified starches like octenyl succinic acid (OSA) with emulsifying properties can be used along with protein sources to form stable oil in water emulsions.

Range of conventional emulsifiers can be used to build the emulsifier system in the products along with the protein component. Examples of conventional emulsifiers are mono and diglycerides of fatty acids, organic acid ester derivatives of mono and diglycerides (Acetic acid esters of mono and diglycerides of fatty acids, Lactic acid esters of mono and diglycerides of fatty acids, Citric acid esters of mono and diglycerides of fatty acids, mono and diacetyl tartacric esters of mono and diglycerides of fatty acids), stearyl-lactylates. Other emulsifiers which can be aid in the formation of emulsion are soy lecithin, polysorbate 60, polysorbate 65, polysorbate 80. The usage of combinations of emulsifier is preferable to have better final product properties.

Carbohydrates are bulking agents which encapsulate the emulsified fat during spray drying. Better encapsulated fat imparts enhanced dispersion of powders on mixing with flour and water for preparation of dough. Carbohydrate usable in the composition preferably comprises of liquid glucose, corn syrup solids, Malto-dextrin 10 to 19 DE range (dextrose equivalent), sucrose, fructose, dextrose and maltose. Hydrocolloids could also be utilized which include Hydroxypropylmethyl cellulose, xanthan gum, K-carragenan, locust bean gum that would contribute dough stability and provide antistaling properties.

Natural or Artificial Flavors such as Vanilla, Caramel, Butter etc. can be added if desired. It can be either added in liquid form to the prepared emulsions prior to spray drying, or in dried form which can be later dry blended with base powder. Preferably salt is used to enhance flavor.

The powder composition of the present invention may also include optional additives typically used in spray dried food powder compositions such as anticaking agents and preservatives. The preferred additives are calcium phosphate, silicate, calcium carbonate and combination thereof while preservatives include calcium propionate, sodium benzoate and potassium sorbet in the present invention. The additives are added in varying amounts, typically about 0.1-1% of the powder.

### Composition and Process of Spray Dried Doughnut Base Powder

The spray dried doughnut base powder of the present invention comprises of fat (20-50%) which could be selected from animal, vegetable or dairy origin along with emulsifiers, stabilizers, carbohydrates, salt.

Preferably, a spray dried doughnut base powder (Table 1) according to the present invention comprises the following components in the emulsion prior to spray drying and in the final powder:

TABLE 1

| | % emulsion | % powder |
|---|---|---|
| | Before spray | After spray |
| Ingredient | drying | drying |
| Vegetable fat or dairy fat or animal fat | 10-25% | 20-50% |
| With antioxidants | | |
| Maltodextrin/Corn syrup | 2-20% | 5-40% |
| solids/sucrose/liquid glucose | | |
| Milk Protein/Soy Protein/Pea Protein | 2-10% | 5-20% |
| Stabilizer and emulsifiers | 0.5-10% | 1-15% |
| Salt | 1-5% | 2-10% |
| Water | Balance to 100 | 2-5% |

An anticaking agent (0.1-1%) can be dry blended with the spray dried doughnut base powder.

Another aspect of the invention is a process for the preparation of a powdered doughnut base powder following above mentioned emulsion formulation. The process comprising the steps of:
a. Preparation of water phase using water soluble ingredients;
b. Preparation of fat phase with melted fat & fat soluble/dispersible ingredients;
c. Addition of fat phase to the water phase and forming oil in water emulsion (approximately solid content about 40 to 60% by weight);
d. Two-stage homogenization (first stage: about 500 psi; second stage: about 2000 psi);
e. Pasteurization of the emulsion and optional addition of liquid flavor compounds;
f. Spray drying the emulsion in a multi-stage spray dryer at an inlet temperature of 200° C. and outlet temperature of 75 C. After the first stage of drying under the chamber powders are further dried and cooled on a moving belt until they reach temperature roughly below 25° C.;
g. The powders are conditioned at 8° C. for 24 hours and
h. Subsequently stored at 20° C.

The prepared spray dried doughnut base powder emulsion has 40-60% solid content and the emulsion is spray dried in a multi-stage spray dryer under pressure nozzle atomization. The viscosity of the emulsion should appropriate for spray drying under nozzle atomization. Too thick emulsions result in poor atomization and powders with inappropriate particle sizes.

A 100 Kg quantity of doughnut base powder was produced by spray drying. The resulting product is a white color free flowing powder with a 20-50% fat content and 3% moisture content. The doughnut base powder is a unique product which has good uniformity and can be easily blended as a bakery ingredient.

The desired quantity of doughnut base powder can be added to the flour and water along with optional color, flavors, emulsifiers and leavening agents in order to get doughnuts of soft texture and improved eating properties.

The following examples are used to illustrate the present invention used to develop processed products, but should not be limited thereto.

### BRIEF DESCRIPTION OF THE TABLES

Table 1 shows contemplated composition of doughnut base powder in the form of an emulsion prior to spray drying, and in the final powder.

Table 2 shows contemplated composition of a yeast raised doughnut prepared using spray dried doughnut base powder.

Table 3 shows contemplated composition of a cake doughnut prepared using spray dried doughnut base powder.

Table 4 shows contemplated composition of a yeast raised doughnut containing egg white powder prepared using spray dried doughnut base powder

Table 5 shows contemplated composition of a yeast raised doughnut containing egg yolk powder prepared using spray dried doughnut base powder

Table 6 shows contemplated composition of a yeast raised doughnut containing both egg white and egg yolk powders prepared using spray dried doughnut base powder

Table 7 shows contemplated composition of a yeast raised doughnut containing whole eggs prepared using spray dried doughnut base powder.

### EXAMPLES

### Example 1

Yeast raised doughnuts was prepared on the basis of the following recipe (Table 2):

TABLE 2

| | Wt % |
|---|---|
| Spray dried doughnut base powder | 12-15% |
| (20-50% fat) | |
| Sweet Cream Whey Powder | 1-2.5% |
| Soy Flour (Full Fat or defatted) | 1-3% |
| Sodium Bicarbonate | 0.1-1% |
| Sodium acid pyrophosphate/mono | 0.1-1% |
| calcium phosphate/sodium | |
| aluminum phosphate | |
| Flavor (Natural or Artificial) such | 0.1-2% |
| as Vanilla, Caramel, Butter | (optional) |
| Enzymes such as Amylase, | 0.1-0.5% |
| protease, lipoxygenase | (optional) |
| Balance with Doughnut Flour/All- | 80%-85% |
| purpose Flour | |

A dry mix for making a yeast raised doughnuts is prepared following above formulation. All the dry components are mixed together in a container for 30 minutes. To 100 g of the above blended mix, yeast (1-3%) and cold water, 2-15° C. (40-50%) was added and blended in food mixer until thick dough was obtained. The dough was then fermented for 10 minutes at room temperature and then rolled into a thick sheet. Doughnut shapes of 75 mm were hand cut from the sheet. The doughnut shapes were fully proofed for 25 minutes at 30-40° C., 55 to 75% relative humidity. 400 g of doughnuts were deep fried in 1500 g of frying fat at 180° C. for 45 seconds per side, lifted out from the frying fat and drained off non-absorbed surface fat. After cooling, finished doughnuts showed light and fluffy fried with a crisp but tender skin, characteristic of classic, quality yeast raised doughnuts.

### Example 2

Cake doughnuts were prepared on the basis of the following recipe (Table 3):

TABLE 3

| | Wt % |
|---|---|
| Spray dried doughnut base powder | 20-25% |
| (20-50% fat) | |
| Sweet Cream Whey Powder | 1-2.5% |
| Soy Flour (Full Fat or defatted) | 1-3% |
| Sodium Bicarbonate/potassium | 0.1-1.2% |
| hydrogen d-tartarate | |
| Sodium acid pyrophosphate/ | 0.1-1.2% |
| monocalciumphosphate/ | |
| sodium aluminium phosphate | |
| Flavor (Natural or Artificial) such | 0.1-2% |
| as Vanilla, Caramel, Butter | (optional) |
| Enzymes such as Amylase, | 0.1-0.5% |
| protease, lipoxygenase | (optional) |
| Balance with Doughnut Flour/All | 80%-85% |
| purpose Flour | |

All the dry components are mixed together in a container for 30 minutes. To 100 g of the above blended mix, cold water, 2-15° C. (40-50%) was added and blended in food mixer until a thick dough was obtained. The dough was then fermented for 10 minutes at room temperature and then rolled into a thick sheet. Doughnut shapes of 75 mm were hand cut from the sheet. 400 g of doughnuts were deep fried in 1500 g of frying fat at 180° C. for 45 seconds per side, lifted out from the frying fat and drained off non-absorbed surface fat. After cooling, finished doughnuts showed light brown, crisp surface, dense and soft texture in the core, characteristic of cake doughnuts.

### Example 3

Yeast raised doughnuts with Egg white solids was prepared on the basis of the following recipe (Table 4):

TABLE 4

| | Wt % |
|---|---|
| Spray dried doughnut base powder | 12%-15% |
| (20-50% fat) | |
| Sweet Cream Whey Powder | 1-2.5% |
| Soy Flour (Full Fat or defatted) | 1-3% |
| Egg white powder | 1-3% |
| Sodium Bicarbonate | 0.1-1% |
| Sodium acid pyrophosphate/ | 0.1-1% |
| monocalcium phosphate/ | |
| sodium aluminium phosphate | |
| Flavor (Natural or Artificial) such | 0.1-2% |
| as Vanilla, Caramel, Butter | (optional) |
| Enzymes such as Amylase, protease, | 0.1-0.5% |
| lipoxygenase | (optional) |
| Balance with Doughnut Flour/All | 80%-85% |
| purpose Flour | |

A dry mix for making a yeast raised doughnuts is prepared following above formulation. All the dry components are mixed together in a container for 30 minutes. To 100 g of the above blended mix, yeast (1-3%) and cold water, 2-15° C. (40-50%) was added and blended in food mixer until a thick dough was obtained. The dough was then fermented for 10 minutes at room temperature and then rolled into a thick sheet. Doughnut shapes of 75 mm were hand cut from the sheet. The doughnut shapes were fully proofed for 25 minutes at 30-40° C., 55 to 75% relative humidity. 400 g of doughnuts were deep fried in 1500 g of frying fat at 180° C. for 45 seconds per side, lifted out from the frying fat and drained off non-absorbed surface fat. After cooling, finished doughnuts showed light brown surface and was soft and light in texture in the core.

### Example 4

Yeast raised doughnuts with Egg yolk solids was prepared on the basis of the following recipe (Table 5):

TABLE 5

| | Wt % |
|---|---|
| Spray dried doughnut base powder | 10%-12% |
| (20-50% fat) | |
| Sweet Cream Whey Powder | 1-2.5% |
| Defatted Soy Flour | 1-3% |
| Egg yolk powder | 1-3% |
| Sodium Bicarbonate | 0.1-0.5% |
| Sodium acid pyrophosphate/ | 0.1-0.5% |
| monocalcium phosphate/ | |
| sodium aluminium phosphate | |
| Flavor (Natural or Artificial) such | 0.1-2% |
| as Vanilla, Caramel, Butter | (optional) |
| Enzymes such as Amylase, | 0.1-0.5% |
| protease, lipoxygenase | (optional) |
| Balance with Doughnut Flour/ | 80%-85% |
| All purpose Flour | |

A dry mix for making a yeast raised doughnuts is prepared following above formulation. All the dry components are mixed together in a container for 30 minutes. To 100 g of the above blended mix, yeast (1-3%) and cold water, 2-15° C. (40-50%) was added and blended in food mixer until a thick dough was obtained. The dough was then fermented for 10 minutes at room temperature and then rolled into a thick sheet. Doughnut shapes of 75 mm were hand cut from the sheet. The doughnut shapes were fully proofed for 25 minutes at 30-40° C., 55 to 75% relative humidity. 400 g of doughnuts were deep fried in 1500 g of frying fat at 180° C. for 45 seconds per side, lifted out from the frying fat and drained off non-absorbed surface fat. After cooling, finished doughnuts showed light brown surface and had a yellow core with a soft and light texture.

### Example 5

Yeast raised doughnuts with Egg white and egg yolk solids were prepared on the basis of the following recipe (Table 6):

TABLE 6

| | Wt % |
|---|---|
| Spray dried doughnut base powder | 10%-12% |
| (20-50% fat) | |
| Sweet Cream Whey Powder | 1-2.5% |
| Defatted Soy Flour | 1-3% |
| Egg white powder | 0.5-2% |
| Egg yolk powder | 0.5-2% |
| Sodium Bicarbonate | 0.1-0.5% |
| Sodium acid pyrophosphate/ | 0.1-0.5% |
| monocalciumphosphate/ | |
| sodium aluminium phosphate | |
| Flavor (Natural or Artificial)such | 0.1-2% |
| asVanilla, Caramel, Butter | (optional) |
| Enzymes such as Amylase, | 0.1-0.5% |
| protease, lipoxygenase | (optional) |
| Balance with Doughnut Flour/ | 80%-85% |
| All-purpose Flour | |

A dry mix for making a yeast raised doughnuts is prepared following above formulation. All the dry components are mixed together in a container for 30 minutes. To 100 g of the above blended mix, yeast (1-3%) and cold water, 2-15° C. (40-50%) was added and blended in food mixer until a thick dough was obtained. The dough was then fermented for 10 minutes at room temperature and then rolled into a thick sheet. Doughnut shapes of 75 mm were hand cut from the sheet. The doughnut shapes were fully proofed for 25 minutes at 30-40° C., 55 to 75% relative humidity. 400 g of doughnuts were deep fried in 1500 g of frying fat at 180° C. for 45 seconds per side, lifted out from the frying fat and drained off non-absorbed surface fat. After cooling, finished doughnuts showed light brown surface and had yellow core which was soft and fluffy texture in the core.

### Example 6

Yeast raised doughnuts with whole eggs was prepared on the basis of the following recipe (Table 7):

TABLE 7

| | Wt % |
|---|---|
| Spray dried doughnut base powder | 15% |
| (20-50% fat) | |
| Sweet Cream Whey Powder | 1-2.5% |
| Soy Flour (Full Fat or defatted) | 1-3% |
| Sodium Bicarbonate | 0.1-1% |
| Sodium acid pyrophosphate/ | 0.1-1% |
| monocalcium phosphate/ | |
| sodium aluminium phosphate | |
| Flavor (Natural or Artificial) such | 0.1-2% |
| as Vanilla, Caramel, Butter | (optional) |
| Enzymes such as Amylase, | 0.1-0.5% |
| protease, lipoxygenase | (optional) |
| Balance with Doughnut Flour/All | 80%-85% |
| purpose Flour | |

A dry mix for making a yeast raised doughnuts is prepared following above formulation. All the dry components are mixed together in a container for 30 minutes. To 100 g of the above blended mix, yeast (1-3%) and cold water, 2-15° C. (40-50%) was added and blended in food mixer until a thick dough was obtained. The dough was then fermented for 10 minutes at room temperature and then rolled into a thick sheet. Doughnut shapes of 75 mm were hand cut from the sheet. The doughnut shapes were fully proofed for 25 minutes at 30-40° C., 55 to 75% relative humidity. 400 g of doughnuts were deep fried in 1500 g of frying fat at 180° C. for 45 seconds per side, lifted out from the frying fat and drained off non-absorbed surface fat. After cooling, finished doughnuts showed light brown surface and were yellow at the core with a very soft and light texture.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A spray dried doughnut powder composition comprising:
20-50% by weight fat,
5-20% by weight protein
1-10% by weight emulsifier,
1-5% by weight stabilizer, and
1-5% by weight water.

2. The spray dried doughnut base powder composition of claim 1, wherein the fat has a slip melting point of at least 30° C.

3. The spray dried doughnut base powder composition of claim 1, further comprising 1-15% by weight of stabilizers and emulsifiers.

4. The spray dried doughnut base powder composition of claim 1, further comprising flavor enhancers.

5. The spray dried doughnut base powder composition of claim 1, further comprising 0.1-1% of anticaking agents dry blended to the spray dried doughnut base powder composition.

6. The spray dried doughnut base powder composition of claim 1, wherein the fat is selected from an animal, vegetable, or dairy origin, and
wherein the fat is modified by complete or partial hydrogenation, fractionation, interesterification, or any combination thereof.

7. The spray dried doughnut base powder composition of claim 1, wherein the protein is selected from the group consisting of caseinate, whey protein base powder or isolates, non-fat dry milk, butter milk powder, soy protein base powder or isolates, wheat proteins, pea protein isolate, gum Arabic, and modified starch with emulsifying properties.

8. The spray dried doughnut base powder composition of claim 1, wherein the powder contains at least 0.1% of one or more emulsifiers selected from the group consisting of mono and diglycerides of fatty acids, organic acid ester derivatives of mono and diglycerides, stearyl-lactylates, soy lecithin, polysorbate 60, polysorbate 65, polysorbate 80, and combinations thereof.

9. The spray dried doughnut base powder composition of claim 1, further comprising a non-starchy carbohydrate bulking agent selected from the group consisting of liquid glucose DE 38-42, sucrose, corn syrup solids, malto-dextrin 10 to 19 DE range, fructose, dextrose and maltose.

10. The spray dried doughnut base powder composition of claim 1, further comprising a starch component that is selected from native corn starch or cross linked modified starch having thickening ability.

11. The spray dried doughnut base powder composition of claim 1, wherein the spray dried doughnut base powder composition is produced by
dissolving all dry ingredients in water to form a water phase,
dissolving all fat soluble/dispersible components in a fat phase,
mixing the fat phase with the water phase in a two stage homogenization to form an oil in water emulsion, and
pasteurizing and spray drying in a multi-stage spray dryer through nozzle atomization thereby forming the spray dried doughnut base powder composition having 20-50% by weight fat.

12. The spray dried doughnut base powder composition of claim 2, wherein the composition is prepared by
(a) blending the fat with the slip melting point of at least 30° C. and at least 0.1% of emulsifiers selected from the group consisting of of mono and diglycerides of fatty acids, organic acid ester derivatives of mono and diglycerides, stearyl-lactylates, soy lecithin, polysorbate 60, polysorbate 65, polysorbate 80;
(b) preparing a homogenous suspension from the blend obtained from step (a); and
(c) atomizing the homogenous suspension into a gaseous or liquid medium with a temperature above the melting point of the fat.

13. The spray dried doughnut base powder of claim 1, wherein the spray dried doughnut base powder is adapted for preparation of dough.

14. An yeast raised doughnut product prepared by mixing the spray dried doughnut base powder composition of claim 1 with other ingredients and yeast leavening.

15. A cake doughnut product prepared by mixing the spray dried doughnut base powder composition of claim 1 as a spray dried doughnut base powder with other ingredients and chemical leavening agents comprising sodium bicarbonate,potassium hydrogen d-tartarate in combination with either sodium acid pyrophosphate, monocalcium phosphate, sodium aluminium phosphate, tartaric acid, fumaric acid.
